(19) United States
(12) Patent Application Publication
(10) Pub. No.: US 2009/0120281 A1
(43) Pub. Date: May 14, 2009

(54) MAGNETIC-TIPPED PISTON

(75) Inventor: Brad Yang, Taichung Hsien (TW)

Correspondence Address: PEARNE & GORDON LLP, 1801 EAST 9TH STREET, SUITE 1200, CLEVELAND, OH, 44114-3108, US

(73) Assignee: TESTO INDUSTRY CORP., Taichung Hsien (TW)

(21) Appl. No.: 11/937,517

(22) Filed: Nov. 9, 2007

(51) Int. Cl. F16J 1/00

(52) U.S. Cl. 92/172

(57) ABSTRACT

A magnetic-tipped piston for a nail gun has a piston head, a driving rod and a magnet. The piston head has a connecting hole. The connecting hole is formed axially through the piston head. The driving rod is connected securely to the piston head and has a connecting end and a driving end. The connecting end is mounted securely in the connecting hole of the piston head. The driving end is formed on and protrudes axially from the connecting end to eject nails out of the nail gun and has a mounting recess. The mounting recess is formed axially in the driving end. The magnet is mounted securely in the mounting recess of the driving rod to attract and hold a head of the nail.

### BACKGROUND OF THE INVENTION

1. Field of the Invention

The present invention relates to a piston, and more particularly to a magnetic-tipped piston for a nail gun ensures nails are held axially with the piston.

2. Description of Related Art

With reference to FIGS. 4 and 5, a conventional nail gun (60) is used for interior decoration, renovation, shoemaking and leatherwear to drive nails (70) into objects and has a front end, a holding tube, a piston (61) and multiple magnetic elements (62). The holding tube is hollow, is formed on the front end of the nail gun (60) and has a tube wall. The piston (61) is mounted movably in the nail gun (60) near the holding tube, is used to push nails (70) out of the nail gun (60) and has a front end. The magnetic elements (62) are mounted in the tube wall of the holding tube, are used to attract and hold the nail (70) in the holding tube and contact with the front end of the piston (61).

However, the nail (70) is not held on a same axis as the piston (61) thereby causing the nail (70) to be ejected into objects at an angle at and reducing quality of final workmanship.

To overcome the shortcomings, the present invention provides a piston to mitigate or obviate the aforementioned problems.

### SUMMARY OF THE INVENTION

The main objective of the present invention is to provide a magnetic-tipped piston for a nail gun that ensures nails are held axially with the piston.

The magnetic-tipped piston for a nail gun in accordance with the present invention has a piston head, a driving rod and a magnet. The piston head has a connecting hole. The connecting hole is formed axially through the piston head. The driving rod is connected securely to the piston head and has a connecting end and a driving end. The connecting end is mounted securely in the connecting hole of the piston head. The driving end is formed on and protrudes from the connecting end and ejects nails out of the nail gun and has a mounting recess formed axially in the driving end. The magnet is mounted securely in the mounting recess of the driving rod to attract and hold a head of the nail.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a magnetic-tipped piston in accordance with the present invention;

FIG. 2 is a perspective view of the magnetic-tipped piston in FIG. 1 mounted in a nail gun and shown in phantom lines;

FIG. 3 is an operational side view in partial section of the nail gun with the magnetic-tipped piston in FIG. 2;

FIG. 4 is a perspective view of a conventional nail gun in accordance with the prior art; and

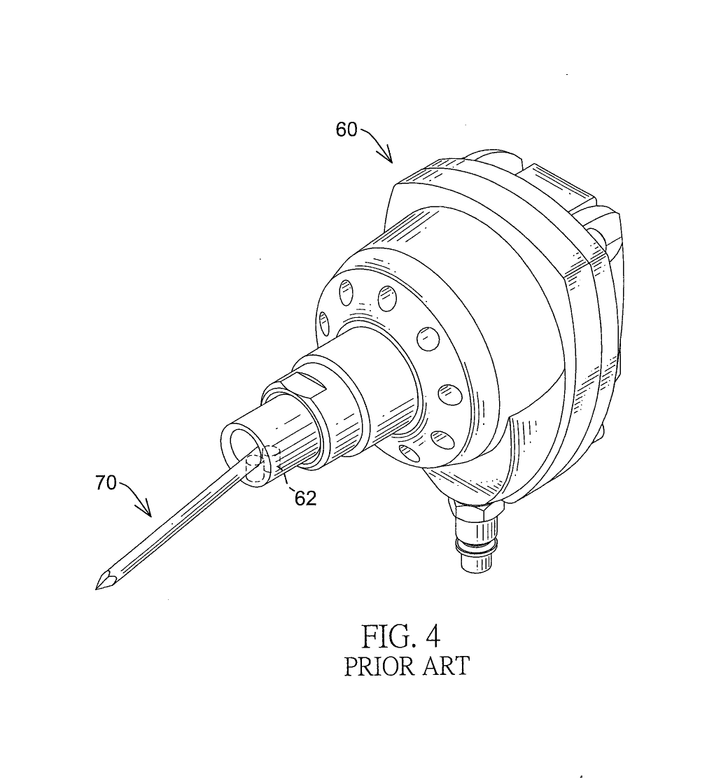

FIG. 5 is an operational side view in partial section of the nail gun in FIG. 4.

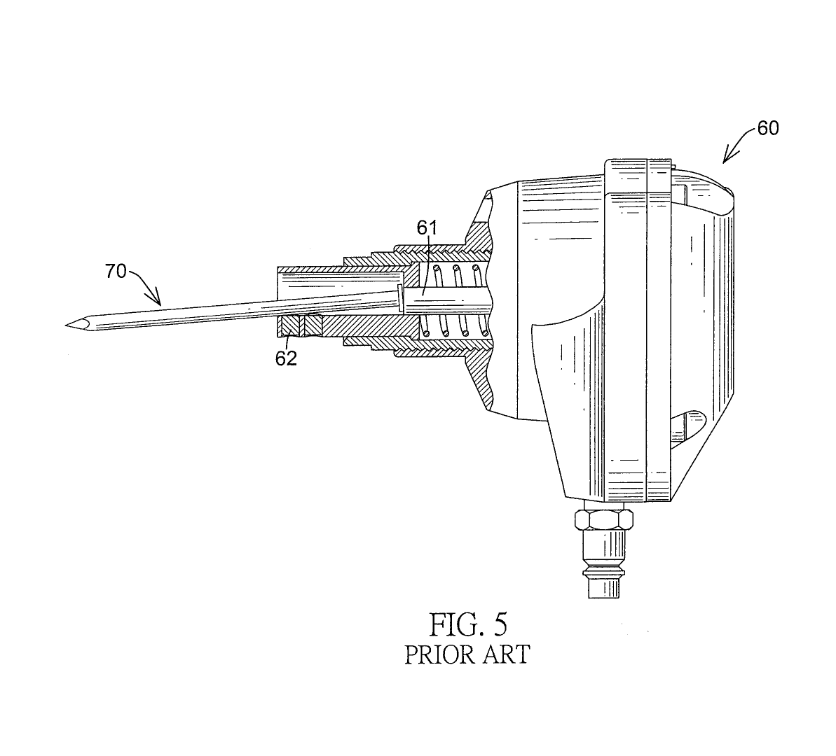

### DETAILED DESCRIPTION OF THE PREFERRED EMBODIMENT

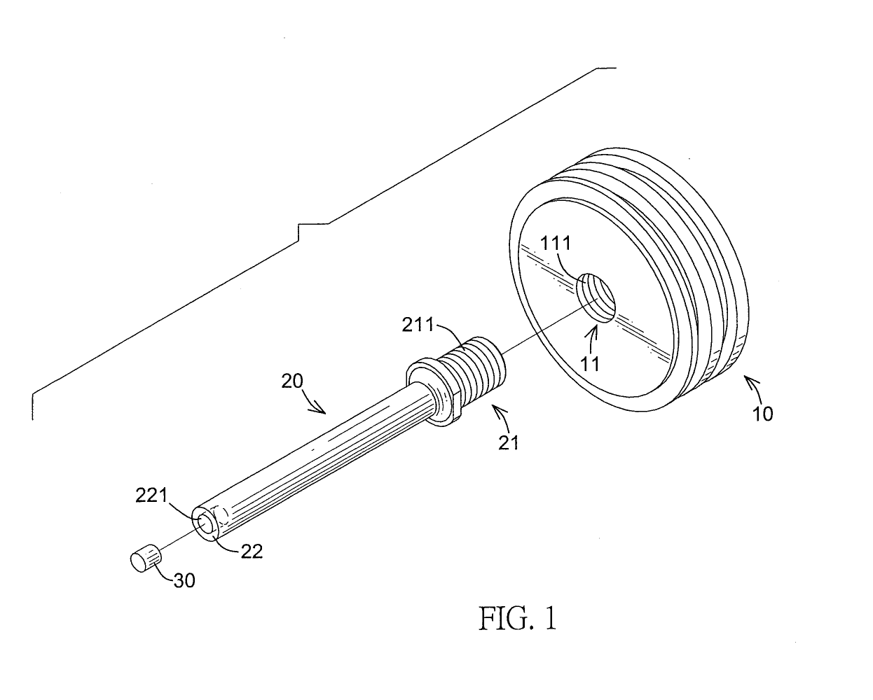

With reference to FIGS. 1 to 3, a magnetic-tipped piston for a nail gun (50) in accordance with the present invention comprises a piston head (10), a driving rod (20) and a magnet (30).

The piston head (10) may be circular and has a connecting hole (11). The connecting hole (11) is formed axially through the piston head (10) and may have an internal surface and an inner thread (111). The inner thread (111) is formed on the internal surface of the connecting hole (11).

The driving rod (20) is connected securely to the piston head (10) and has a connecting end (21) and a driving end (22). The connecting end (21) is mounted in the connecting hole (11) of the piston head (10) and may have an external surface and an outer thread (211). The outer thread (211) is formed on the external surface of the connecting end (21), corresponding to and is screwed onto the inner thread (111) of the connecting hole (11) in the piston head (10). The driving end (22) is formed on and protrudes axially from the connecting end (21), is used to eject nails (40) out of the nail gun (50) and has a mounting recess (221). The mounting recess (221) is formed axially in the driving end (22).

The magnet (30) is mounted securely in the mounting recess (221) of the driving rod (20), is used to attract a head of the nail (40).

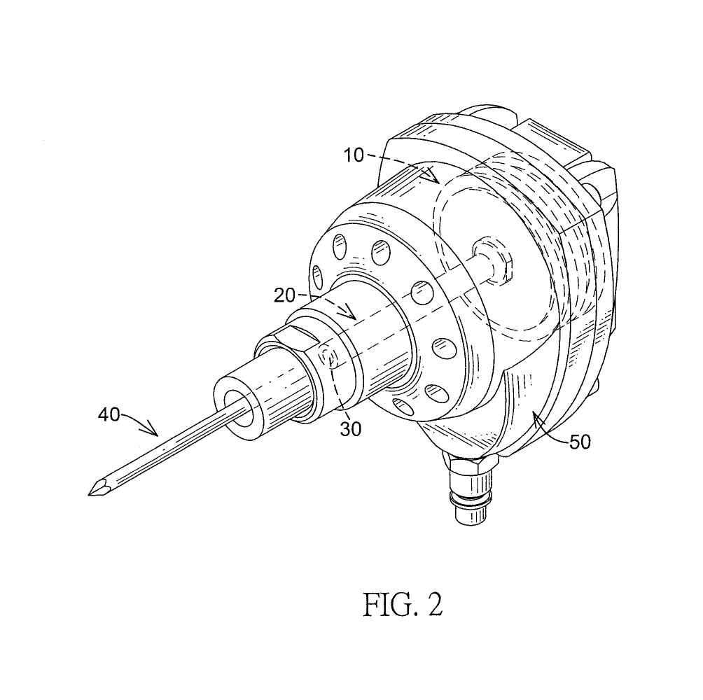

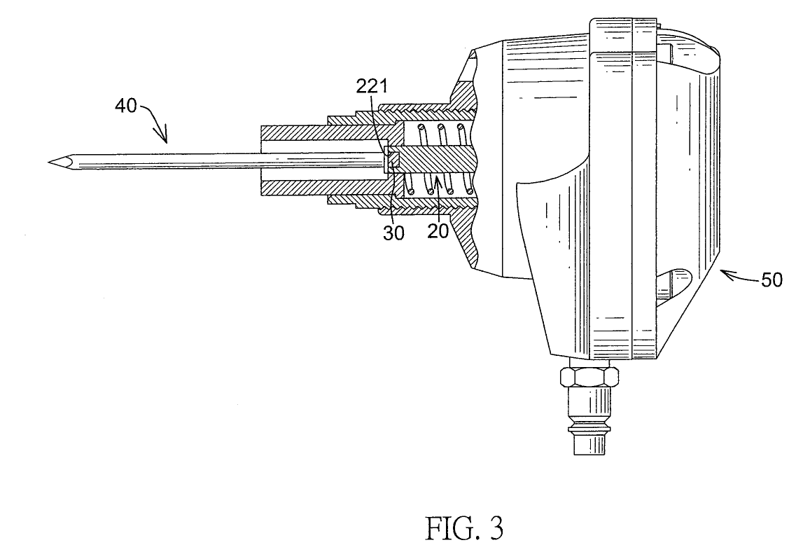

With reference to FIGS. 2 and 3, the magnet (30) is mounted axially in the mounting recess (221) of the driving rod (20), to attract and hold the nail (40) axially with the driving rod (20) thereby preventing the nail (40) from entering an object at an angle from the piston head and improving final workmanship.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A piston for a nail gun having
a piston head having a connecting hole being formed axially through the piston head;
a driving rod being connected securely to the piston head and having
a connecting end being mounted securely in the connecting hole of the piston head; and
a driving end being formed on and protruding axially from the connecting end to eject nails out of the nail gun and having a mounting recess being formed axially in the driving end; and
a magnet being mounted securely in the mounting recess of the driving rod to attract and hold a head of the nail.

2. The piston as claimed in claim 1, wherein
the connecting hole of the piston head further has
an internal surface; and
an inner thread being formed on the internal surface of the connecting hole; and
the connecting end of the driving rod further has
an external surface; and
an outer thread being formed on the external surface of the connecting end, corresponding to and being screwed onto the inner thread of the connecting hole in the piston head.

3. The piston as claimed in claim 2, wherein the piston head is circular.

4. The piston as claimed in claim 1, wherein the piston head is circular.
